(19) United States
(12) Patent Application Publication
(10) Pub. No.: US 2009/0216643 A1
(43) Pub. Date: Aug. 27, 2009

(54) Data processing system and data processing method

(75) Inventor: Yasuhiro Yamada, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/380,362

(22) Filed: Feb. 26, 2009

(30) Foreign Application Priority Data
Feb. 27, 2008 (JP) P2008-046085

(51) Int. Cl. G06Q 30/00; G06Q 99/00

(52) U.S. Cl. 705/14; 705/1

(57) ABSTRACT

Disclosed herein is a data processing system including: a user manager configured to manage user identification data for identifying a user and a page of the user by relating them each other; a data manager configured to manage service data and the user identification data by relating them each other; and a link manager configured to manage link data for linking a page of one user to a page of another user other than the page of the one user; wherein, when an operation for moving service data of the one user to a page of another user linked by the link data is executed, the data manager clears the relation between the user identification data of the one user and the service data to be moved and newly relates user identification data of the another user to whom the move is executed and the service data to be moved.

### CROSS REFERENCES TO RELATED APPLICATIONS

The present invention contains subject matter related to Japanese Patent Application JP 2008-046085 filed in the Japan Patent Office on Feb. 27, 2008, the entire contents of which being incorporated herein by reference.

### BACKGROUND OF THE INVENTION

1. Field of the Invention

The present invention relates to a data processing system and a data processing method that are configured to use relations of trust already formed in a community to distribute electronic coupon with a highly reliable form.

2. Description of the Related Art

A data management system is known in which advertisement is distributed to television monitors arranged in public spaces and television monitors in homes and electronic coupon of such as discount associated with the distributed advertisement is delivered to user terminal devices owned and managed by users (refer to Japanese Patent Laid-Open No. 2005-301586). A data processing system is also known in which, after getting electronic coupon, users introduce the obtained coupon to their friends for example on Web sites, thereby adding incentives of such as new discounts to each act of introduction.

With such data processing systems, electronic coupon is delivered to those introduced by introducer's transmitting the electronic mail of the introduced to a website operating company.

However, with the above-mentioned data processing systems, there is no confirmation of the relation of trust between the introducing party and the introduced party, while an incentive is added to the introducing party for each action of introduction. Therefore, with the above-mentioned data processing systems, it is expected that there arrive floods of introducing mail messages from unacquainted persons for example, many of which are so-called spam mail.

### SUMMARY OF THE INVENTION

Therefore, the present invention addresses the above-identified and other problems associated with related-art methods and apparatuses and solves the addressed problems by providing a data processing system and a data processing method that are configured to distribute electronic coupons with high reliability by use of the relation of trust already formed in a community.

In carrying out the invention and according to one embodiment thereof, there is provided a data processing system. This data processing system has user management means for managing user identification data for identifying a user and a page of the user by relating the user management data with the page; data management means for managing service data and the user identification data by relating the service data with the user identification data; and link management means for managing link data for linking a page of one user to a page of another user other than the page of the one user; wherein, when an operation for moving service data of the one user to a page of another user linked by the link data is executed, on the page of the one user, by a user terminal device connected via a network, the data management means clears the relation between the user identification data of the one user and the service data to be moved and newly relates user identification data of the another user to whom the move is executed and the service data to be moved.

In carrying out the invention and according to another embodiment thereof, there is provided a data processing method for a data processing system having user management means for managing user identification data for identifying a and a page of the user by relating the user management data with the page, data management means for managing service data and the user identification data by relating the service data with the user identification data, and link management means for managing link data for linking a page of one user to a page of another user other than the page of the one user. This data processing method including the steps of executing an operation for moving service data of the one user to a page of another user linked by the link data, on the page of the one user, by a user terminal device connected via a network; and clearing the relation between the user identification data of the one user and the service data to be moved and newly relating user identification data of the another user to whom the move is executed and the service data to be moved, by the data management means.

As described and according to the invention, service data of one user can be moved, on a page of this user, to a page of another user linking to that user. Therefore, embodiments of the present invention can prevent the reception of service data from users other than above-mentioned another user linked to above-mentioned one user, which in turn prevents above-mentioned one user from receiving increasing spam mail.

### BRIEF DESCRIPTION OF THE DRAWINGS

FIG. 1 is a schematic diagram illustrating an exemplary overall configuration of a data processing system practiced as one embodiment of the invention;

FIG. 2 is a block diagram illustrating an exemplary configuration of a community management server;

FIG. 3 is a block diagram illustrating a coupon management server;

FIG. 4 is a block diagram illustrating an exemplary configuration of a coupon distribution server;

FIG. 5 is a block diagram illustrating an exemplary configuration of a user terminal device;

FIG. 6 is a diagram illustrating a Web page in the case of an SNS (Social Networking Service);

FIG. 7 is a diagram illustrating a Web page in the case of an IM (Instant Messenger);

FIG. 8 is a block diagram illustrating an exemplary configuration of a store terminal device;

FIG. 9 is a flowchart indicative of a sequence of operations to be executed when moving or copying coupon data from one user to another if a business entity managing a community management server and a business entity managing a coupon management server are the same or in the relation of trust; and

FIG. 10 is a flowchart indicative of a sequence of operations to be executed when moving or copying coupon data from one user to another if a business entity managing a community management server and a business entity managing a coupon management server are different or out of the relation of trust.

### DETAILED DESCRIPTION OF THE PREFERRED EMBODIMENTS

This invention will be described in further detail by way of embodiments thereof with reference to the accompanying drawings. Now, the following describes a data processing system 1 practiced as one embodiment of the invention.

The data processing system 1 is configured to move or copy, on a Web site providing services to predetermined users who can use these services only if introduced by a user already registered in the Web site such as an SNS (Social Networking Service) or an IM (Instant Messenger) for example, coupon data owned by one user to the other one or more users of Web pages linked to a Web page of one user on this Web site, such as a user belonging to a community to which a user having common interests for example on this Web site.

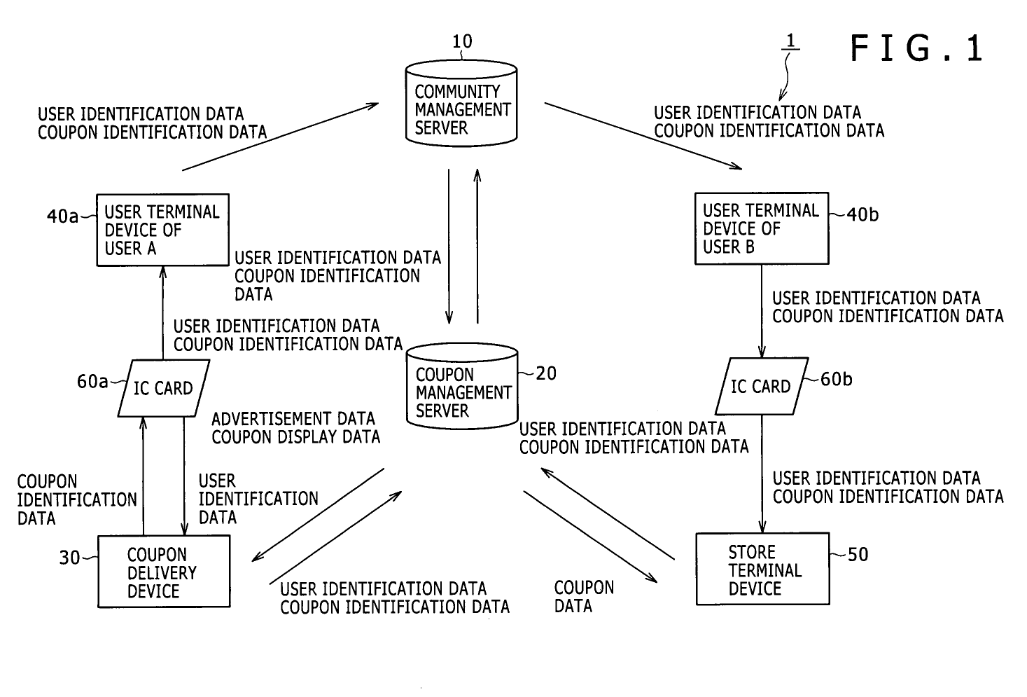

As shown in FIG. 1, the data processing system 1 has a community management server 10 for managing a Web site, such as an SNS or an IM, a coupon management server 20 for managing coupon data to be distributed as well as distributing coupon data, a coupon delivery device 30 for delivering coupon data distributed from the coupon management server 20, user terminal devices 40a, 40b (hereafter generically referred to also as a user terminal device 40) for storing the coupon data delivered from the coupon delivery device 30, and a store terminal device 50 having a POS (Point of Sale) function arranged at a store for example.

With the data processing system 1 configured as described above, the community management server 10 is interconnected to the coupon management server 20 and two or more user terminal device 40 via a network and the coupon management server 20 is interconnected to the community management server 10, the coupon delivery device 30, and the store terminal device 50 via a network.

It should be noted that, if a business entity managing the community management server 10 and the business entity managing the coupon management server 20 are the same or in the relation of trust, for example, the data processing system 1 may connect the community management server 10 with the coupon management server 20 via a leased line or a VPN (Virtual Private Network) that is a virtual private network built by use of the Internet.

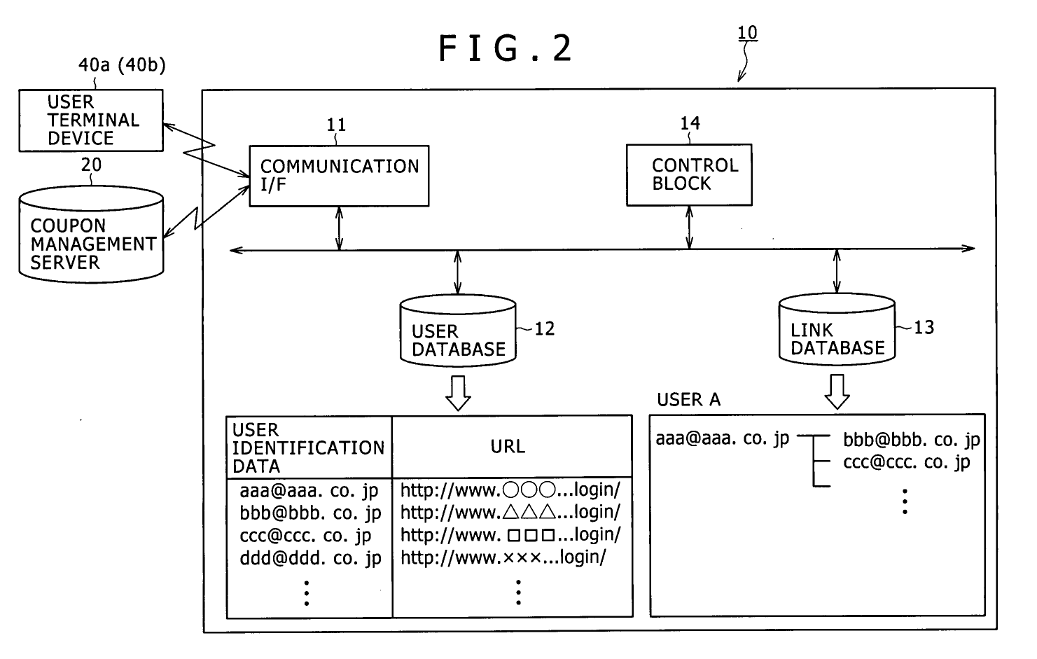

The community management server 10 is a server unit that is managed by a Web site operating business entity that is operating a Web site, such as an SNS or an IM, for example. As shown in FIG. 2, this community management server 10 has a communication interface (hereafter also referred to simply as a communication I/F) 11 that provides communication with the coupon management server 20 and the two or more user terminal devices 40 that use the Web site, a user database 12 for storing user identification data for identifying users of the Web site and URLs (Uniform Resource Locators) of Web pages of users on the Web site by correlating the user identification data and the URLs, a link database 13 for storing link data for linking the Web page of one user with the Web page of another, and a control block 14 for controlling operations of the entire community management server 10. It should be noted that the communication I/F 11, the user database 12, the link database 13, and the control block 14 are interconnected via a PCI (Peripheral Component Interconnect) bus for example.

The communication I/F 11, connected to the coupon management server 20 and the user terminal device 40 of one or more users using the Web site, communicates therewith by following a protocol, such as TCP/IP (Transmission Control Protocol/Internet Protocol) for example, thereby receiving various kinds of data from the coupon management server 20 and the user terminal device 40 via a network, such as the Internet, and transmitting various kinds of data thereto.

It should be noted that, if the business entity managing the community management server 10 and the business entity managing the coupon management server 20 are the same or in the relation of trust, the communication I/F 11 may be connected to the coupon management server 20 via a leased line or the VPN that is a virtual private network built by use of the Internet.

The user database 12, built on a hard disk for example, stores, for the user identification data of each user using a Web site such as SNS and IM, a Web page URL allocated to the user on the Web site and a password set by this user by relating the URL and the password each other. When the user accesses the Web site and the user identification data and the password are entered by the user, the user database 12 identifies whether this user is a member of the Web site and authenticates this user.

Here, the user identification data is the data unique to the user terminal device 40, a memory terminal device, or a small-size or mobile information processing device, for example, owned and managed by the use; to be more specific, the electronic mail address of the user terminal device 40, the card identification data of an IC card that is the memory terminal device, and the electronic mail address and telephone number of a mobile phone that is the small-size or mobile information processing device, for example. To be still more specific, when electronic mail address “aaa@aaa.co.jp” that is the user identification data of user A is entered for user A, the user database 12 stores this electronic mail address “aaa@aaa.co.jp” and URL “http://www.OOO ••• login/” by relating the electronic mail address and the URL each other.

The link database 13 stores the link data that links the Web page of one user using the Web site to the Web page of another. To be more specific, the link database 13 stores link data in which the user identification data of one user is related with the user identification data of another. For example, the link database 13 stores the link data in which electronic mail address “aaa@aaa.co.jp” that is the user identification data of user A is related with electronic mail address “bbb@bbb.co.jp” that is user identification data of user B. Also, when one user belongs to a community on the Web page, for example, the link database 13 stores the link data in which the URL of the community is related with the user identification data of one user.

The control block 14, configured by a CPU (Central Processing Unit), a ROM (Read Only Memory), a RAM (Random Access Memory), and so on, temporarily reads, into the RAM, a control program from the ROM storing the control program for controlling operations of the community management server 10 to execute predetermined computational processing by means of the CPU as instructed by the control program, thereby controlling the operations of the entire community management server 10.

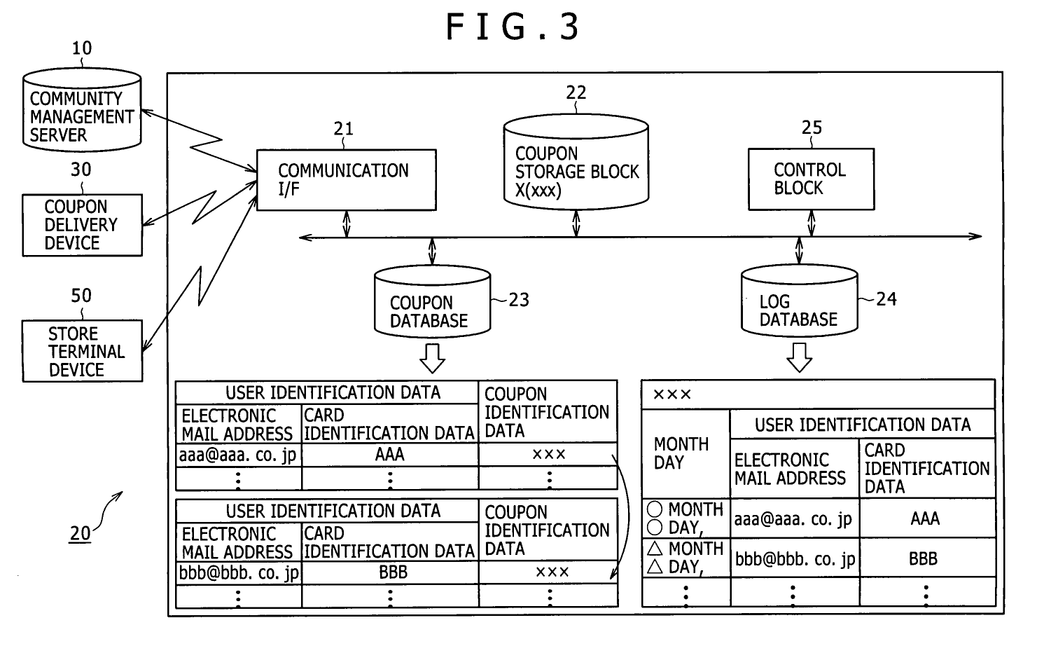

The coupon management server 20 is a server device that is managed by an advertisement agency for example. Advertisement data provided by a coupon client and coupon identification data are entered in the coupon management server 20, which sequentially distributes coupon display data for displaying the contents of coupon data in streaming for example to the coupon delivery device 30. As shown in FIG. 3, this coupon management server 20 has a communication I/F 21 for executing communication with the community management server 10, the coupon delivery device 30, and the store terminal device 50 via a network, a coupon storage block 22 for storing the advertisement data and the coupon display data to be distributed from the communication I/F 21 to the coupon delivery device 30, a coupon database 23 for storing the coupon identification data obtained by one user by relating this coupon identification data with the user identification data of one user who obtained coupon data, a log database 24 for storing log data of owners for example of coupon data, and a control block 25 for controlling operations of the entire coupon management server 20. It should be noted that the communication I/F 21, the coupon storage block 22, the coupon database 23, the log database 24, and the control block 25 are interconnected by a PCI bus for example.

The communication I/F 21, connected to the community management server 10, the coupon delivery device 30, and the store terminal device 50 via a network, such as the Internet, executes communication by following a protocol, such as TCP/IP for example, to receive various kind of data from the community management server 10, the coupon delivery device 30, and the store terminal device 50 via the network, such as the Internet, and transmit various kind of data thereto.

It should be noted that, if the business entity managing the community management server 10 and the business entity managing the coupon management server 20 are the same or in the relation of trust, the communication I/F 21 may be connected to the community management server 10 via a leased line or the VPN that is a virtual private network built by use of the Internet.

The coupon storage block 22, configured by a hard disk drive for example, stores the advertisement data provided by a coupon client from a coupon client terminal, not shown, via a network, such as the Internet, coupon data, and the coupon display data for displaying the contents of coupon with coupon identification data inserted. For example, the advertisement data is data for introduction to the store of the coupon client. The coupon data is discount data, such as discount data like 5% discount of 5-day Mongol tour offered by AA travel agency, 10% discount data of product “CC” offered by BB store, all-product 1000-yen discount data of DD store, or the like, these discount data being indicated by coupon data “X,” for example, coupon data “Y,” and coupon data “Z,” respectively. The coupon display data is coupon display data “XXX” for displaying the contents of coupon data “X” and coupon data “X” in icons for example on the coupon delivery device 30 or the user terminal device 40, for example. Coupon identification data “xxx” is inserted in the coupon display data “XXX.” Likewise, coupon identification data “yyy” is inserted in coupon display data “YYY” of coupon data “Y” and coupon identification data “zzz” is inserted in coupon display data “ZZZ” of coupon “Z.” It should be noted that the coupon management server 20 may store, in the coupon storage block 22, the advertisement data, coupon data, and coupon display data provided by the coupon client via a recording media, such as optical disk, a magnetic disk, or a semiconductor memory, for example.

The coupon database 23, built on a hard disk drive for example, stores user identification data and coupon identification data by relating the user identification data of one user who got coupon data with the coupon identification data of obtained by the user. To be more specific, when user A gets coupon data “A,” for example, the coupon database 23 relates coupon identification data “xxx” of coupon data “X” with electronic mail address “aaa@aaa.co.jp” that is the user identification data of user A and the user identification data of card identification data “AAA” that is the user identification data of user A of an IC card 60a owned and managed by user A and stores these related data.

The log database 24, built on a hard disk drive for example, stores the log data of coupon data owners for example. To be more specific, the log database 24 stores the user identification data of user A who got coupon data “X,” the date data on which coupon data “X” was obtained, the user identification data of user B who is a new owner to whom coupon data “X” was moved to copied, the date data on which coupon data “X” was moved or copied, the store identification data for identifying a store for which coupon data “X” was used, and the date data on which coupon data “X” was used by relating these data with coupon identification data “xxx” of coupon data “X.”

The control block 25, configured by a CPU, a ROM, a RAM, and so on, temporarily reads, into the RAM, a control program from the ROM storing the control program to execute predetermined computational processing by means of the CPU as instructed by the control program, thereby controlling the operations of the entire coupon management server 20.

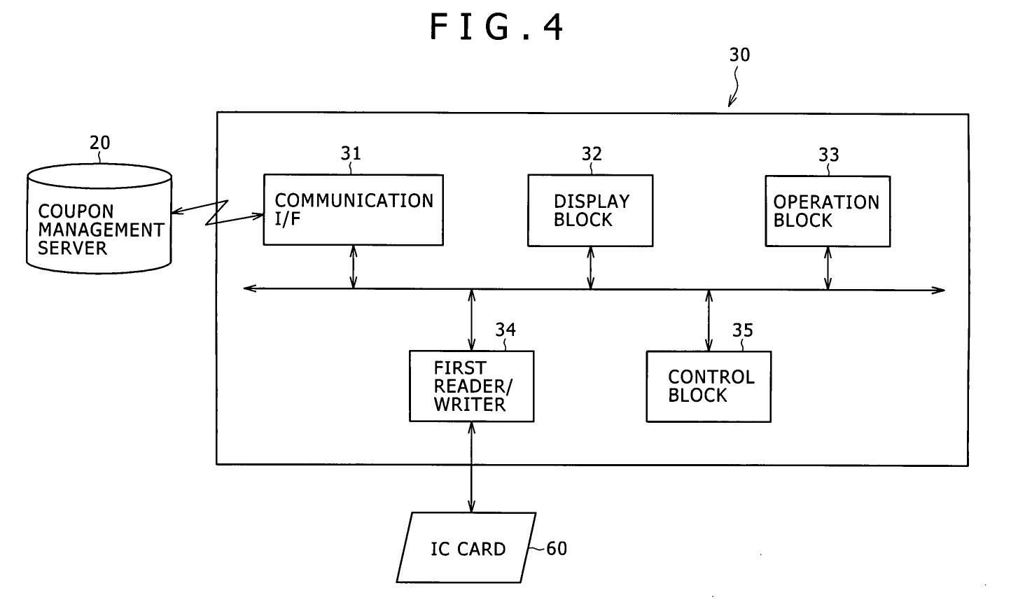

As shown in FIG. 4, The coupon delivery device 30 is a digital signage for example that is installed in a public space, such as a hotel lobby or a railroad station, for example, and has a communication I/F 31 for executing communication with the coupon management server 20 via a network, a display block 32 for displaying the advertisement data and coupon display data received from the coupon management server 20 via the communication I/F 31, an operation block 33 on which operations for getting coupon data from the coupon display data displayed on the display block 32 are executed by the user, a first reader/writer over which the IC card 60 owned and managed by the user is held, and a control block 35 for controlling operations of the entire coupon delivery device 30. It should be noted that the communication I/F 31, the display block 32, the operation block 33, the first reader/writer 34, and the control block 35 are interconnected via a PCI bus for example.

The communication I/F 31, connected to the coupon management server 20 via a network, such as the Internet, executes communication by following a protocol, such as TCP/IP for example, to receive various kinds of data from the coupon management server 20 via the network, such as the Internet, and transmit various kinds of data thereto.

The display block 32, configured by a CRT (Cathode Ray Tube) or an LCD (Liquid Crystal Display) for example, displays the advertisement data and coupon display data streaming-distributed from the coupon management server 20.

The operation block 33, configured by pushbuttons and so on, is operated by the user to get coupon data, such as selecting coupon data from the coupon display data displayed on the display block 32 for example.

The first reader/writer 34 executes short-distance or near-distance wireless communication, such as RFID (Radio Frequency Identification System) or NFC (Near Field Communication) for example, with the IC card 60 owned and managed by the user to write various kinds of data to the IC card 60 and read various kinds of data therefrom. To be more specific, the first reader/writer 34, when the IC card 60a owned and managed by user A is held thereon, executes short-distance or near-distance communication with the IC card 60a, thereby writing coupon identification data “xxx” of coupon data “X” selected by user A through the operation block 33 and reading the user identification data of user A.

The control block 35, configured by a CPU, a ROM, a RAM, and so on, temporarily reads, into the RAM, a control program from the ROM storing the control program to execute predetermined computational processing by means of the CPU as instructed by the control program, thereby controlling the operations of the entire coupon delivery device 30.

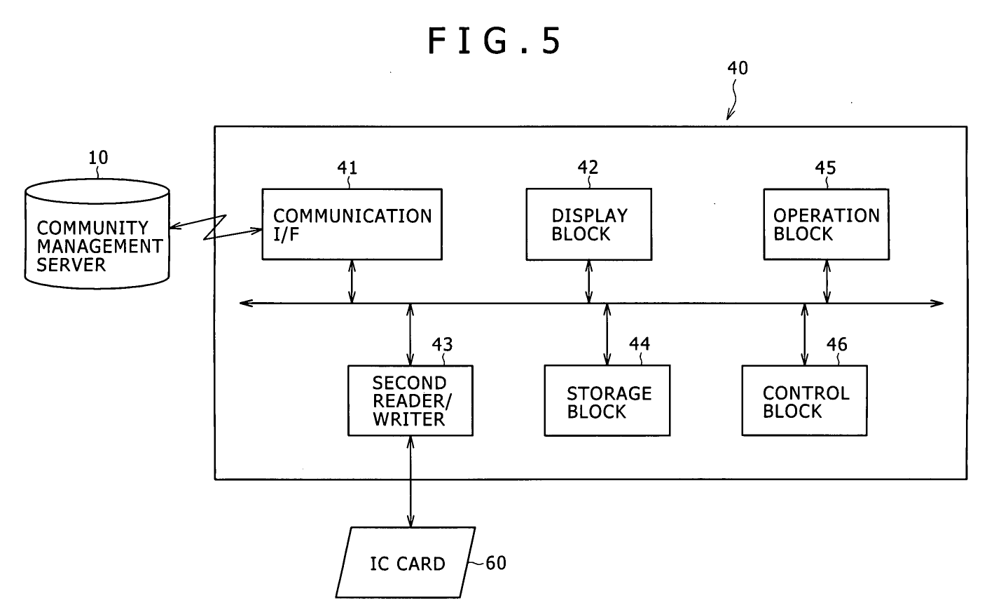

The user terminal device 40, as shown in FIG. 5, is an information processing device owned and managed by the user, for example, and has a communication I/F 41 for executing communication with the community management server 10 via a network, a display block 42 for displaying a Web site managed by the community management server 10, a second reader/writer 43 over which an IC card 60 owned and managed by the user is held, a storage block 44 for storing various data such as obtained coupon data, an operation block 45 on which various operations are executed by the user, and a control block 46 for controlling operations of the entire user terminal device 40. It should be noted that the communication I/F 41, the display block 42, the second reader/writer 43, the storage block 44, the operation block 45, and the control block 46 are interconnected via a PCI bus for example.

The communication I/F 41, connected to the community management server 10 via a network, such as the Internet, executes communication by following a protocol, such as TCP/IP for example, to receive various kinds of data from the community management server 10 via the network, such as the Internet, and transmit various kinds of data thereto.

The display block 42, configured by a CRT or an LCD for example, displays a Web page allocated to a Web site managed by the community management server 10 when the user logs in the Web site.

The second reader/writer 43 executes wireless communication of RFID or NFC for example with the IC card 60 owned and managed by the user to write various kinds of data to the IC card 60 and read various kinds of data therefrom. To be more specific, when the IC card 60a owned and managed by user A is held over the second reader/writer 43, the second reader/writer 43 executes short-distance or near-distance wireless communication with the IC card 60a to read coupon identification data “xxx” and the user identification data of user A from the IC card 60a; when the IC card 60b of user B is held over the second reader/writer 43, the second reader/writer 43 executes short-distance or near-distance wireless communication with the IC card 60b to write coupon identification data “xxx” and the user identification data of the user B to the IC card 60b.

The storage block 44, configured by a hard disk drive for example, stores various kinds of data, such as coupon identification data and user identification data owned by the user.

The operation block 45, configured by a mouse, a keyboard, and so on, is operated by the user when the user executes an operation of logging in on a Web site, linking a Web page of another user to the Web page of the user on the Web page, and an operation of moving or copying the coupon identification data owned by one user to another user on the Web page.

The control block 46, configured by a CPU, a ROM, a RAM, and so on, temporarily reads, into the RAM, a control program from the ROM storing the control program to execute predetermined computational processing by means of the CPU as instructed by the control program, thereby controlling the operations of the entire user terminal device 40.

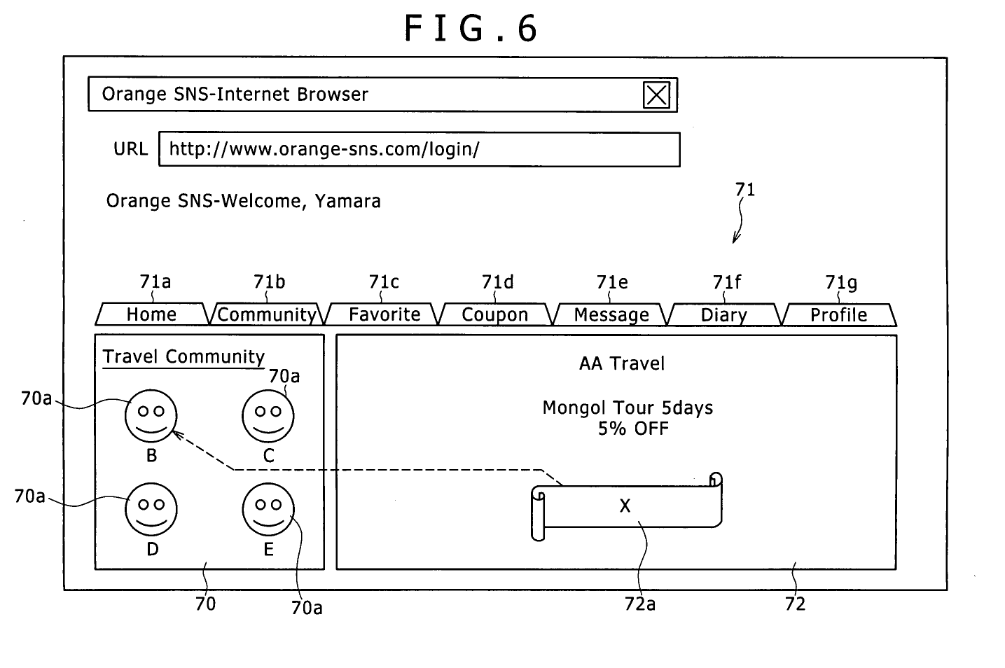

The following describes a Web page that is displayed on the display block 42 of the user terminal device 40. In the case of an SNS, as shown in FIG. 6, the Web page displays a first display block 70 for displaying another user of a Web page linked to a Web page of one user, for example, menu icons 71 for displaying various screens for executing various functions of the Web site, such as “Home,” “Community,” “Favorite,” “Coupon,” “Message,” “Diary,” “Profile,” and so on, and a second display block 72 for displaying various screen in accordance with these menu icons 71.

The first display block 70 list-displays, in an icon 70a for example, another user of a Web page linked to a Web page of one user. To be more specific, when user A logs in on a Web site, link data for user A is read by the control block 14 of the community management server 10 from the link database 13, a community, such as a travel community for example to which user A belongs, is read from the link data, users B and C belonging to this community are identified, namely, users B and C of Web pages linked to the Web page of user A via the -community are identified, and then users D and E of Web pages linked to the Web page of user A are identified from the link data without passing the community. The first display block 70 displays, in the form of a list, these identified other users B, C, D, and E in the icons 70a for example.

“Home” icon 71a displays, on the second display block 72, a Web page previously set by one user by selecting from various screens to be described later, as an initial screen.

“Community” icon 71b displays, on the second display block 72, a community application screen for applying the registration with a desired community by one user.

“Favorite” icon 71c displays, on the second display block 72, a link screen for linking to Web pages of other users displayed on the second display block 72.

“Coupon” icon 71d displays, on the second display block 72, a coupon introduction screen for displaying, in a list, the coupon data owned by one user in an icon 72a and so on according to the coupon display data. The user selects the icon 72a of coupon data “X” by operating the operation block 45 such as mouse for example, drags the icon 72a of selected coupon data “X” to the icon 70a of one of the users displayed on the first display block 70 and drops the dragged icon 72a there, which allows the user to move or copy the selected coupon data to other desired users.

“Message” icon 71e displays, on the second display block 72, a message input screen for transferring messages with other users on the Web site and transmitting membership registration messages to friends for examples not registered with this Web site to prompt the friends to access a member registration screen.

“Diary” icon 71f displays a diary input screen to which a diary is written onto the second display block 72.

“Profile” icon 71g displays, on the second display block 72, a profile input screen in which profile items, such as name, address, birth place, and interests, are entered.

The second display block 72 displays various screens in accordance with the above-mentioned menu icons 71. On each screen displayed on the second display block 72, the user can execute various functions on the Web site by operating the operation block 45, such as mouse and keyboard, for example.

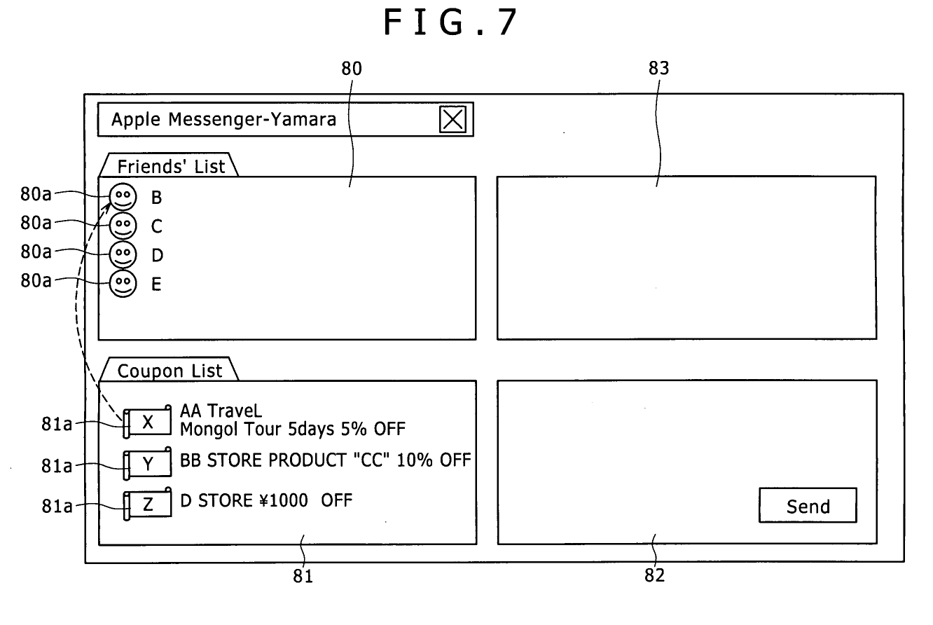

In the case of IM, as shown in FIG. 7, a Web page has a first display block 80 for displaying other users of a Web page linking to a Web page of one user for example, a second display block 81 for displaying the coupon identification data owned by one user, a third display block 82 to which a message can be written for other users on the Web site, and a fourth display block 83 for displaying the message written to the third display block 82.

The first display block 80 displays, in icon 80a for example, other users of a Web page linking to a Web page of one user on the Web site. To be more specific, when user A logs in on a Web site, link data for user A is read by the control block 14 of the community management server 10 from the link database 13, a community, such as a travel community for example to which user A belongs, is read from the link data, users B and C belonging to this community are identified, namely, users B and C of Web pages linked to the Web page of user A via the community are identified, and then users D and E of Web pages linked to the Web page of user A are identified from the link data without passing the community. The first display block 80 displays, in the form of a list, these identified other users B, C, D, and E in the icons 80a for example.

The second display block 81 displays, in a list, the coupon data owned by one user in icon 81a for example according to the coupon display data. The user selects the icon 81a of coupon data “X” by operating the operation block 45 such as mouse for example, drags the icon 81a of selected coupon data “X” to the icon 80a of one of the users displayed on the first display block 70 and drops the dragged icon 81a there, which allows the user to move or copy the selected coupon data to other desired users.

The third display block 82 allows one user to write messages to other users of Web pages linking to the Web page of one user on the Web site. The fourth display block 83 displays the messages written to the third display block 82 and written by other users.

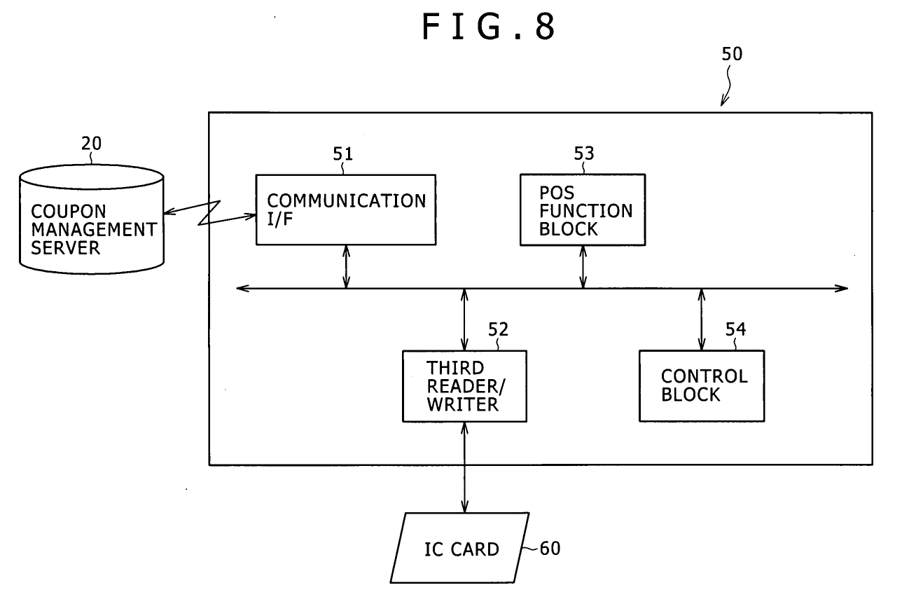

The store terminal device 50 is a device having a function of POS (Point of Sale) terminal installed at each product selling store as shown in FIG. 8 and has a communication I/F 51 for executing communication with the coupon management server 20 via a network, a third reader/writer 52 over which the IC card 60 owned and managed by the user is held, a POS function block 53 for realizing the function as a POS terminal, and a control block 54 for controlling operations of the entire store terminal device 50. It should be noted that the communication I/F 51, the third reader/writer 52, the POS function block 53, and the control block 54 are interconnected via a PCI bus for example.

The communication I/F 51, connected to the coupon management server 20 via a network, such as the Internet, executes communication by following a protocol, such as TCP/IP for example, to receive various kinds of data from the coupon management server 20 and transmit various kinds of data thereto.

The third reader/writer 52 executes wireless communication of RFID or NFC for example with the IC card 60 owned and managed by the user to write various kinds of data to the IC card 60 and read various kinds of data therefrom. To be more specific, when the IC card 60b owned and managed by user B is held over the third reader/writer 52, the third reader/writer 52 executes short-distance or near-distance wireless communication with the IC card 60b to read coupon identification data “xxx” and the user identification data of user B from the IC card 60b, thereby reading coupon identification data “xxx” and the user identification data of user B from the IC card 60b.

The POS function block 53 has a reader for example for optically reading barcodes for example attached to products, thereby reading one-dimensional or two-dimensional symbols such as barcodes attached to products. Also, when the IC card 60 owned and managed by the user is held over the third reader/writer 52 to enter coupon identification data by the third reader/writer 52, the POS function block 53 identifies the coupon data related with this coupon identification data by the coupon management server 20 from this coupon identification data, thereby executing settlement processing for a purchased product in accordance with the identified coupon data.

The control block 54, configured by a CPU, a ROM, a RAM, and so on, temporarily reads, into the RAM, a control program from the ROM storing the control program to execute predetermined computational processing by means of the CPU as instructed by the control program, thereby controlling the operations of the store terminal device 50.

The following describes a sequence of procedures necessary for user A to own coupon data “X” in the data processing system 1 configured as described above.

First, the control block 25 of the coupon management server 20 sequentially distributes the advertisement data provided by coupon client and stored in the coupon storage block 22 and coupon display data “XXX” with coupon identification data “xxx” inserted therein to the coupon delivery device 30 in steaming for example, thereby displaying the data on the display block 32 of the coupon delivery device 30.

Then, when coupon data “X” is selected from one or more items of coupon display data displayed on the display block 32 of the coupon delivery device 30 by an operation by user A through the operation block 33 and the IC card 60a owned and managed by user A is held over the first reader/writer 34, the control block 35 of the coupon delivery device 30 writes the coupon identification data “xxx” of the selected coupon data “X” to the IC card 60a through the first reader/writer 34 and reads card identification data “AAA” of the IC card 60a that is the user identification data of user A.

Next, the control block 35 of the coupon delivery device 30 transmits the card identification data “AAA” that is the user identification data of user A read from the IC card 60a and coupon identification data “xxx” written to the IC card 60a to the coupon management server 20.

Next, the control block 25 of the coupon management server 20 relates coupon identification data “xxx” with card identification data “AAA” that is the received user identification data of user A to store these related data into the coupon database 23. Also, the control block 25 of the coupon management server 20 relates log data, such as date data on which coupon data “X” was obtained and card identification data “AAA” of the IC card 60a that is the user identification data of user A owned and managed by user A who obtained coupon data “X” with received coupon identification data “xxx” and stores these related data into the log database 24.

Then, the control block 46 of the user terminal device 40a of user A reads card identification data “AAA” that is the user identification data of user A and coupon identification data “xxx” from the IC card 60a through the second reader/writer 43 for example and stores the read data into the storage block 44.

Thus, user A can get coupon data “X,” namely, coupon identification data “xxx,” from the coupon delivery device 30 to own the obtained coupon data “X.”

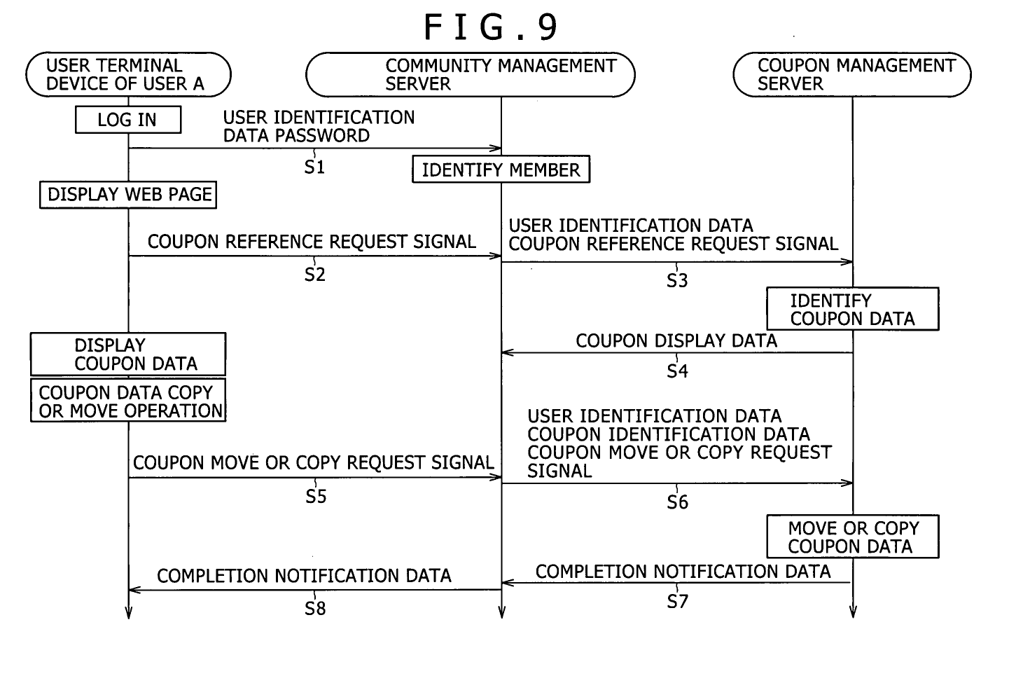

The following describes, with reference to FIG. 9, a sequence of procedures to be executed by the data processing system 1 when, if the business entity managing the community management server 10 and the business entity managing coupon management server 20 are the same or in the relation of trust, moving or copying coupon data “X” owned by user A to another user B of a Web page linking to a Web page of user A via a community on the Web page by user A's logging in on the Web site. It should be noted that the following describes a sequence of procedures to be executed by the data processing system 1 when user A moves or copies coupon data “X” owned by user A on a Web site of an SNS.

In step S1, when the Web site is accessed by user A from the user terminal device 40a of user A via a network, such as the Internet, the control block 14 of the community management server 10 displays the top page of the Web site on the display block 42 of the user terminal device 40a of user A.

Next, when electronic mail address “aaa@aaa.co.jp” that is the user identification data of user A and a password thereof are entered by user A through the operation block 45, such as a keyboard for example, the control block 14 of the community management server 10 identifies if user A is a member of this Web site by means of the user database 12 and authenticates that the login user is user A himself.

Next, upon identifying user a to be a member, the control block 14 of the community management server 10 allows the user to log in on the Web site and identifies URL “http://www.OOO ••• login/” of the Web page of user A from electronic mail address “aaa@aaa.co.jp” that is the user identification data of user A and the password thereof, thereby displaying the Web page of user A onto the display block 42 of the user terminal device 40a of user A.

The following describes a sequence of procedures to be executed by the data processing system 1 when user A makes registration with the Web site.

When the Web site is accessed from the user terminal device 40a of user A via a membership registration message transmitted from the message input screen on the Web site by a registered user or a membership registration screen icon of a top page, not shown, is specified, the control block 14 of the community management server 10 displays a membership registration screen on the display block 42 of the user terminal device 40a of user A.

Next, when electronic mail address “aaa@aaa.co.jp” that is the user identification data of user A and the password thereof are entered on the membership registration screen by user A through the operation block 45, such as a keyboard for example, the control block 14 of the community management server 10 relates electronic mail address “aaa@aaa.co.jp” that is the user identification data of user A and the password thereof with URL “http://www.OOO ••• login/” of the Web page allocated to the Web site of user A and stores these related data into the user database 12. Then, the control block 14 of the community management server 10 displays a registration completed notification on the user terminal device 40a of user A. Thus, user A can make registration with the Web site.

When Web site login processing has been executed in the procedure mentioned above, the control block 14 of the community management server 10 reads the link data related with electronic mail address “aaa@aaa.co.jp” that is the user identification data of user A from the link database 13, identifies a community, such as a travel community for example, to which user A belongs from the link data, identifies users B, C belonging to this community, namely, identifies other users B, C of the Web pages linking to the Web page of user A via the community, and then identifies other users D, E of the Web pages linked to the Web page of user A from the link data without passing the community. Then, the control block 14 of the community management server 10 displays, on the display block 42 of the user terminal device 40a of user A, a screen displayed with identified other users B, C, D, E in icons 70a for example in a list on the first display block 70 of the Web page of user A as shown in FIG. 6. In addition, the control block 14 of the community management server 10 displays the initial screen preset by user A onto the second display block 72 of the Web page of user A.

The following describes a sequence of procedures to be executed by the data processing system 1 when user A belongs to a community.

When “Community” icon 71b is specified by user A through the operation block 45, such as mouse for example, the control block 14 of the community management server 10 displays a community application screen onto the display block 42 of the user terminal device 40a of user A and, on the community application screen, displays a desired community, a travel community for example, onto the second display block 72 by use of a search block for example, not shown.

Next, when an operation for membership application to a community was executed by user A through the operation block 45, such as mouse for example, and the participation of user A in this community has been approved by a community manager for example, the control block 14 of the community management server 10 stores link data with the URL of this communication related with electronic mail address “aaa@aaa.co.jp” that is the user identification data of user A into the link database 13.

Then, in accordance with the new link data, the control block 14 of the community management server 10 displays a screen for displaying other users B, C belonging to this communication onto the first display block 70 of the Web page of user A in icons 70a for example.

Thus, the Web page of user A can be linked to the Web pages of other users B, C belonging to this community via the community.

The following describes a sequence of procedures to be executed by the data processing system 1 when user A links to the Web page of other user D on the Web page without passing a community.

When “Favorite” icon 71c is specified by user A through the operation block 45, such as mouse for example, the control block 14 of the community management server 10 displays the link application screen on the display block 42 of the user terminal device 40a of user A and, on the link application screen, displays the Web page of desired user D onto the second display block 72 by use of a search block, not shown.

Next, when an operation of linking the Web page of user A with the Web page of user D was executed by user A through the operation block 45, such as mouse, and the linking to user A has been approved by user D, the control block 14 of the community management server 10 stores, in the link database 13, the link data with electronic mail address “ddd@ddd.co.jp” that is the user identification data of user D related with electronic mail address “aaa@aaa.co.jp” that is the user identification data of user A.

Then, in accordance with the new link data, the control block 14 of the community management server 10 displays user D on the first display block 70 of the Web page of user A in icon 70a for example and displays user A on the first display block 70 of the Web page of user D in icon 70a for example.

Thus, the Web page of user A can be linked to the Web page of user D without passing the community.

After the Web page is displayed in the procedure described above, when “Coupon” icon 71d is specified by user A through the operation block 45, such as mouse, and a coupon reference request signal is received from the user terminal device 40a of user A in step S2, the control block 14 of the community management server 10 reads card identification data “AAA” that is the user identification data of user A from the storage block 44 of the user terminal device 40a of the first user and transmits the read card identification data “AAA” that is the user identification data of user A and the coupon reference request signal to the coupon management server 20 via VPN in step S3.

Receiving the card identification data “AAA” that is the user identification data of user A and the coupon reference signal from the community management server 10 via VPN, the control block 25 of the coupon management server 20 authenticates the coupon reference request signal from user A himself by trusting the result of authenticating user A in the community management server 10 managed by the same business entity or the business entity in the relation of trust, thereby identifying the coupon identification data owned by user A from the card identification data “AAA” that is the user identification data of user A by the coupon database 23. Then, in step S4, the control block 25 of the coupon management server 20 transmits coupon display data for displaying the contents of the coupon of the identified coupon data to the community management server 10.

The community management server 10 displays a coupon introduction screen on the second display block 72 of the user terminal device 40a of user A, thereby displaying a list of the coupon data owned by user A in icon 72a for example in accordance with the received coupon display data on the coupon introduction screen.

It should be noted that, in step S3, the control block 14 of the community management server 10 may further read electronic mail address “aaa@aaa.co.jp” that is the user identification data of user A from the storage block 44 of the user terminal device 40a and transmit the read electronic mail address “aaa@aaa.co.jp” that is the user identification data of user A to the coupon management server 20, which further relates the electronic mail address “aaa@aaa.co.jp” that is the user identification data of user A with card identification data “AAA” that is the user identification data of user A and the coupon identification data “xxx” related with the coupon database 23 and stores these related data.

In step S5, the community management server 10 reads card identification data “AAA” that is the user identification data of user A and coupon identification data “xxx” from the storage block 44 of the user terminal device 40a when icon 72a, on the coupon introduction screen, of coupon data “X” to be moved or copied from the second display block 72 when the operation is executed by user A through the operation block 45, such as mouse for example, an operation is executed to move or copy coupon data “X” owned by user A in the user terminal device 40a to user B of a Web page linked to the Web page of user A via a community by dragging and dropping the selected coupon data “X” to icon 70a of user B in the first display block 70, for example, the move or copy of coupon data “X” is approved by user B, and a coupon move request signal or a coupon copy request signal is received from the user terminal device 40a of user A.

Next, in step S6, the community management server 10 reads electronic mail address “bbb@bbb.co.jp” that is the user identification data of user B from the user database 12 and transmits card identification data “AAA” that is the user identification data of user A, coupon identification data “xxx,” electronic mail address “bbb@bbb.co.jp” that is the user identification data of user B, and the coupon move request signal or the coupon copy request signal to the coupon management server 20 via VPN. Likewise, the community management server 10 transmits card identification data “AAA” that is the user identification data of user A, coupon identification data “xxx,” and electronic mail address “bbb@bbb.co.jp” that is the user identification data of user B to the user terminal device 40b of user B, storing these data into the storage block 44.

Then, receiving these card identification data “AAA” that is the user identification data of user A, coupon identification data “xxx,” electronic mail address “bbb@bbb.co.jp” that is the user identification data of user B, and coupon move request signal from the community management server 10 via VPN, the control block 25 of the coupon management server 20 authenticates the coupon move request signal from user A himself by trusting the authentication result authenticating user A by the community management server 10 managed by the same business entity or the business entity in the relation of trust in the same manner as step S3 described above and relates coupon identification data “xxx” with electronic mail address “bbb@bbb.co.jp” that is the user identification data of user B, thereby storing these related data into the coupon database 23. Then, the control block 25 of the coupon management server 20 clears, on the basis of the coupon database 23, the relation between card identification data “AAA” that is the user identification data of user A and coupon identification data “xxx” to be moved to user B.

Receiving card identification data “AAA” that is the user identification data of user A, coupon identification data “xxx,” electronic mail address “bbb@bbb.co.jp” that is the user identification data of user B, and the coupon copy request signal from the community management server 10 via VPN, the control block 25 of the coupon management server 20 authenticates the coupon copy request signal from user A himself by trusting the authentication result authenticating user A by the community management server 10 managed by the same business entity or the business entity in the relation of trust in the same manner as step S3 described above and relates coupon identification data “xxx” with electronic mail address “bbb@bbb.co.jp” that is the user identification data of user B, thereby storing these related data into the coupon database 23.

Further, the control block 25 of the coupon management server 20 relates log data, such as the date data on which coupon data “X” was moved or copied and electronic mail address “bbb@bbb.co.jp” that is the user identification data of user B who got coupon data “X” with the moved or copied coupon identification data “xxx” and stores these related data into the log database 24.

Next, in step S7, the control block 25 of the coupon management server 20 transmits completion notification data for notifying the completion of move or copy of coupon data “X” to the community management server 10. In step S8, the control block 14 of the community management server 10 transmits the received completion notification data to the user terminal device 40a of user A and the user terminal device 40b of user B.

Thus, if the business entity managing the community management server 10 and the business entity managing the coupon management server 20 are the same or in the relation of trust, user A can move or copy, on the Web side of SNS, coupon data “X” owned by user A, namely, coupon identification data “xxx,” to user B of the Web page linking to the Web page of user A.

It should be noted that an only difference between SNS and IM is that, while coupon display data is displayed with a procedure of step S2 through step S4 after the specification of “Coupon” icon 71d in the case where the Web site is on SNS, coupon display data is displayed automatically with the same procedure of step S2 through step S4 after the authentication of the member in the case where the Web site is on SNS.

If the Web site is on IM, as shown in FIG. 7, coupon data “X” owned by user A, namely, coupon identification data “xxx,” can be moved or copied to user B of the Web page linking to the Web page of user A with the same procedure of step S5 through step S8 by dragging and dropping coupon data “X” to icon 80a of user B of the image display block 80 for example after selecting icon 81a of coupon data “X” to be moved or copied from the second display block 81 by user A through the operation block 45 such as mouse.

Thus, if the business entity managing the community management server 10 and the business entity managing the coupon management server 20 are the same or in the relation of trust, user A can move or copy, on the Web site of IM, coupon data “X” owned by user A, namely, coupon identification data “xxx” to user B of the Web page linking to the Web page of user A.

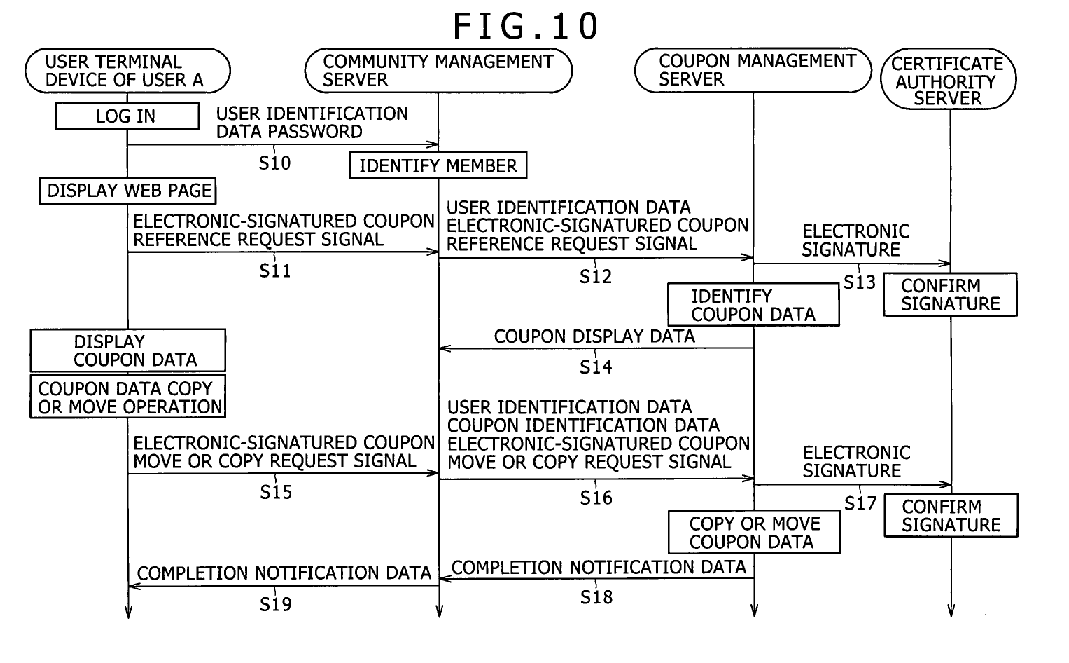

The following describes, with reference to FIG. 10, a sequence of procedures to be executed by the data processing system 1 when user A logs in on a Web site to move or copy coupon data “X” owned by user A to another user B of a web page linking to the Web page of user A via a community on the Web page in the case where the business entity managing the community management server 10 and the business entity managing coupon management server 20 are different or not in the relation of trust.

The case where the business entity managing the community management server 10 and the business entity managing coupon management server 20 are different or not in the relation of trust differs from the case where the business entity managing the community management server 10 and the business entity managing the coupon management server 20 are the same or in the relation of trust in that a certification authority server executes signature check to see if various signals are those transmitted from user A himself by transmitting these signals outputted from the user terminal device 40a of user A by attaching electronic signature.

The certification authority server herein denotes a server device that is managed by a trusted third-party organization for issuing electronic certificates for certifying data transmitting parties. For the certification authority server, a general-purpose server is used, so that detail description thereof will be skipped. The main function of this server is that the transmitting party transmits data attached with an electronic certificate issued by the certification authority server, which allows the transmitting party itself can certificate the transmission of data and, at the same time, the receiving party to make sure of the transmitting party that from which the data was received.

In what follows, if the same procedure applies as that when the business entity managing the community management server 10 and the business entity managing the coupon management server 20 are the same or in the relation of trust, then the description of such a procedure will be skipped.

In step S10, the procedure takes place same as step S1 when the business entity managing the community management server 10 and the business entity managing the coupon management server 20 are the same or in the relation of trust, so that the description is skipped.

After the Web page logged in by user A has been displayed, the control block 46 of the user terminal device 40 transmits a coupon reference request signal attached with electronic signature to the community management server 10 when “Coupon” icon 71d is specified by user A through the operation block 45 such as mouse in step S11.

In step S12, the control block 14 of the community management server 10 reads card identification data “AAA” that is the user identification data of user A from the storage block 44 of user terminal device 40a of user A and transmits the read card identification data “AAA” that is the user identification data of user A and the coupon reference request signal with electronic signature to the coupon management server 20.

In step S13, receiving the card identification data “AAA” that is the user identification data of user A and the coupon reference request signal attached with electronic signature from the community management server 10, the control block 25 of the coupon management server 20 transmits the electronic signature to the certification authority server to execute signature check to see if the received coupon reference request signal is that from user A himself. Then, if the coupon reference request signal is found by the certification authority server to be that from user A himself, the control block 25 of the coupon management server 20 identifies, on the basis of the coupon database 23, the coupon identification data owned by user A from the card identification data “AAA” that is the user identification data of user A.

In step S14, the control block 25 of the coupon management server 20 transmits the coupon display data for displaying the contents of the identified coupon data to the community management server 10.

Next, the control block 14 of the community management server 10 displays a coupon introduction screen on the second display block 72 of the user terminal device 40a of user A, thereby displaying a list of coupon data owned by user A in icons 72a in accordance with the received coupon display data.

In step S15, the control block 46 of the user terminal device 40 transmits the coupon move request signal or the coupon copy request signal to the community management server 10 by attaching electronic signature on the coupon introduction screen if the move or copy of coupon data “X” is approved by user B when icon 72a of coupon data “X” to be moved or copied from the second display block 72 is selected by user A through the operation block 45 such as mouse and an operation of moving or copying selected coupon data “X” owned by user A to user B of the Web page linking the Web page of user A via the community is executed on the user terminal device 40a by dragging and dropping the selected coupon data “X” to icon 70a of user B of the first display block 70, for example.

In step S16, the control block 14 of the community management server 10 reads card identification data “AAA” that is the user identification data of user A and coupon identification data “xxx” from the storage block 44 of the user terminal device 40a of user A and then reads electronic mail address “bbb@bbb.co.jp” that is the user identification data of user B from the user database 12 and transmits these card identification data “AAA” that is the user identification data of user A, coupon identification data “xxx,” electronic mail address “bbb@bbb.co.jp” that is the user identification data of user B, and coupon move request signal or coupon copy request signal with electronic signature to the coupon management server 20. Also, the community management server 10 transmits these card identification data “AAA” that is the user identification data of user A, coupon identification data “xxx,” and electronic mail address “bbb@bbb.co.jp” that is the user identification data of user B to the user terminal device 40b of user B to store these data into the storage block 44.

In step S17, receiving card identification data “AAA” that is the user identification data of user A, coupon identification data “xxx,” electronic mail address “bbb@bbb.co.jp” that is the user identification data of user B, and coupon move request signal attached with electronic signature, the control block 25 of the coupon management server 20 transmits the electronic signature to the certification authority server to execute signature check to see if the coupon move request signal is that from user A himself.

Then, if the coupon move request signal is found by the certification authority server to be the signal from user A himself, the control block 25 of the coupon management server 20 relates coupon identification data “xxx” with the received electronic mail address “bbb@bbb.co.jp” that is the user identification data of user B and stores these related data into the coupon database 23. Next, the control block 25 of the coupon management server 20 clears the relation between card identification data “AAA” that is the user identification of user A and coupon identification data “xxx” to be moved to user B.

Also, receiving card identification data “AAA” that is the user identification data of user A, coupon identification data “xxx,” electronic mail address “bbb@bbb.co.jp” that is the user identification data of user B, and coupon copy request signal attached with electronic signature, the control block 25 of the coupon management server 20 transmits the electronic signature to the certification authority server to execute signature check to see if the coupon copy request signal is that from user A himself.

Next, if the coupon copy request signal is found by the certification authority to be the signal from user A himself, the control block 25 of the coupon management server 20 relates coupon identification data “xxx” with the received electronic mail address “bbb@bbb.co.jp” that is the user identification data of user B and stores these related data into the coupon database 23.

Further, the control block 25 of the coupon management server 20 relates log data, such as the date data on which coupon data “X” was moved or copied and electronic mail address “bbb@bbb.co.jp” that is the user identification data of user B who got coupon data “X” with the moved or copied coupon identification data “xxx” and stores these related data into the log database 24.

Next, in step S18, the control block 25 of the coupon management server 20 transmits completion notification data for notifying the completion of move or copy of coupon data “X” to the community management server 10. In step S19, the control block 14 of the community management server 10 transmits the received completion notification data to the user terminal device 40a of user A and the user terminal device 40b of user B.

Thus, if the business entity managing the community management server 10 and the business entity managing the coupon management server 20 are different or not in the relation of trust, user A can move or copy, on the Web side of SNS, coupon data “X” owned by user A, namely, coupon identification data “xxx,” to user B of the Web page linking to the Web page of user A.

It should be noted that an only difference between SNS and IM is that, while coupon display data is displayed with a procedure of step S11 through step S14 after the specification of “Coupon” icon 71d in the case where the Web site is on SNS, coupon display data is displayed automatically with the same procedure of step S11 through step S14 after the authentication of the member in the case where the Web site is on SNS.

If the Web site is on IM, as shown in FIG. 7, coupon data “X” owned by user A, namely, coupon identification data “xxx,” can be moved or copied to user B of the Web page linking to the Web page of user A with the same procedure of step S15 through step S19 by dragging and dropping coupon data “X” to icon 80a of user B of the image display block 80 for example after selecting icon 81a of coupon data “X” to be moved or copied from the second display block 81 by user A through the operation block 45 such as mouse.

Thus, if the business entity managing the community management server 10 and the business entity managing the coupon management server 20 are different or not in the relation of trust, user A can move or copy, on the Web site of IM, coupon data “X” owned by user A, namely, coupon identification data “xxx” to user B of the Web page linking to the Web page of user A.

The following describes a sequence of procedures to be executed by the data processing system 1 when user B to whom coupon data “X” has been moved or copied from user A via the community uses the moved or copied coupon “X” at a store.

When the IC card 60b owned and managed by user B is held over the second reader/writer 43, the control block 46 of the user terminal device 40b of user B writes coupon identification data “xxx” stored in the storage block 44 and electronic mail address “bbb@bbb.co.jp” that is the user identification data of user B to the IC card 60b through the second reader/writer 43.

Next, when user B or a store personnel operates an operation block, not shown and holds the IC card 60b owned and managed by user B over the third reader/writer 52, the control block 54 of the store terminal device 50 reads electronic mail address “bbb@bbb.co.jp” that is the user identification data of user B and coupon identification data “xxx” from the IC card 60b of user B through the third reader/writer 52. Then, the control block 54 of the store terminal device 50 transmits the read electronic mail address “bbb@bbb.co.jp” that is the user identification data of user B and coupon identification data “xxx” to the coupon management server 20.

Then, the control block 25 of the coupon management server 20 identifies coupon data “X” from the received coupon identification data “xxx” on the basis of the coupon database 23, transmitting the identified coupon data “X” to the store terminal device 50.

The control block 54 of the store terminal device 50 executes settlement processing of a purchased product through the POS function block by use of the received coupon data “X.” Next, the control block 54 of the store terminal device 50 relates log data, such as date data on which coupon data “X” was used, electronic mail address “bbb@bbb.co.jp” that is the user identification data of user B who used coupon data “X,” and store identification data of the store at which coupon data “X” was used with coupon identification data “xxx” of the used coupon data “X” and transmits these related data to the coupon management server 20.

Next, the control block 25 of the coupon management server 20 receives the log data and stores the received log data into the log database 24, identifies, from the log database 24, a user immediately before user B who used coupon data “X” from the received electronic mail address “bbb@bbb.co.jp” that is the user identification data of user B, namely, user A who moved or copied the coupon data “X” used by user B to user B, and relates electronic mail address “aaa@aaa.co.jp” that is the user identification data of the identified user A with incentive data such as coupon data having a discount rate higher than a discount rate of the coupon data used by user B for example, storing these related data into the coupon database 23.

Thus, user B can use coupon data “X” moved or copied from user A. Also, user A who moved or copied, to user B, coupon data “X” used by user B, can get incentive.

It should be noted that the control block 54 of the store terminal device 50 may transmit the used data of coupon data “X” to the coupon management server 20 after the settlement processing to prevent the duplicate use of the used coupon data “X” and, upon reception of the used data of coupon data “X” from the store terminal device 50, the control block 25 of the coupon management server 20 may clear, on the coupon database 23, the relation of coupon identification data “xxx” of the used coupon data “X” with electronic mail address “bbb@bbb.co.jp” that is the user identification data of user B.

The data processing system 1 having the above-mentioned configuration can move or copy, on a Web site, coupon data “X” owned by user A to one or more user B of Web pages linking to the Web page of user A.

Further, the data processing system 1 can protect user B against receiving coupon data from users of a certain degree of trust of being linkable to the Web page of user B on a Web site, thereby preventing spam mail from increasing.

Still further, when user B introduced with coupon data “X” from user A on the Web site has purchased products at a store or used coupon data “X,” the data processing system 1 can give incentive to user A who actually introduced coupon data “X” to user B.

In addition, the data processing system 1 allows each coupon client to understand, by referencing the log data, efficient coupon introduction routes through which communities, thereby executing campaigns aimed at particular groups by making the most of the aggregation property of each community.

It should be noted that the data processing system 1 may use the IC card 60 owned and managed by each user in which the electronic mail address of the user terminal device 40 is stored in advance. This setup allows the data processing system 1 to use only the electronic mail address of the user terminal device 40 as user identification data without use of card identification data as user identification data, thereby facilitating data management.

Also, the data processing system 1 is not limited to the configuration in which the IC card 60 is used as a memory terminal owned by managed by each user; for example, the memory terminal may be a small-size or portable information processing device, such as a non-mobile phone or a PDA (Personal Digital (Data) Assistant).

Besides, the data processing system 1 is not limited to the configuration in which coupon identification data is provided to the user terminal device 40 via a memory terminal, such as the IC card 60; it is also practicable to distribute advertisement data and coupon data from the coupon delivery device 30 directly to the user terminal device 40, thereby letting the user terminal device 40 get the coupon data. This setup allows the data processing system 1 to use only the electronic mail address of the user terminal device 40 of the user as the user identification data without use of the card identification data as user identification data, thereby facilitating data management.

Further, the data processing system 1 is not limited to the configuration in which such data unique to the user terminal device 40, the memory terminal device, and the small-size or portable information processing device as electronic mail addresses as user identification data is used; for example, if the community management server 10 and the coupon management server 20 are operated by the same business entity, the user identification data common to users may be assigned to manage coupon data by use of the common user identification data instead of electronic mail addresses.

Still further, if the community management server 10 and the coupon management server 20 are operated by different business entities, the data processing system 1 may have a configuration in which the different business entities assign user identification data to users, create a management table for example in which these user identification data are related with each other between the different business entities by use of the created management table beforehand, thereby managing the user identification data instead of electronic mail addresses by use of the management table.

While preferred embodiments of the present invention have been described using specific terms, such description is for illustrative purpose only, and it is to be understood that changes and variations may be made without departing from the spirit or scope of the following claims.

What is claimed is:

1. A data processing system comprising:
user management means for managing user identification data for identifying a user and a page of said user by relating said user management data with said page;
data management means for managing service data and said user identification data by relating said service data with said user identification data; and
link management means for managing link data for linking a page of one user to a page of another user other than said page of said one user;
wherein, when an operation for moving service data of said one user to a page of another user linked by said link data is executed, on said page of said one user, by a user terminal device connected via a network, said data management means clears the relation between the user identification data of said one user and said service data to be moved and newly relates user identification data of said another user to whom said move is executed and said service data to be moved.

2. The data processing system according to claim 1, wherein, when an operation for copying service data of said one user to a page of another user linked by said link data is executed, on said page of said one user, by a user terminal device connected via a network, said data management means newly relates user identification data of said another user to whom said copy is executed and said service data to be copied.

3. The data processing system according to claim 2, further comprising:
log management means for managing a log of an owner of said service data subject to one of move and copy operations.

4. The data processing system according to claim 3, wherein, when used data is entered via a network from a store terminal installed at a store where said service data has been used, said data management means references said log management means to relate incentive data with user identification data of a user immediately before a user who used said service data.

5. A data processing method for a data processing system having user management means for managing user identification data for identifying a user and a page of said user by relating said user management data with said page, data management means for managing service data and said user identification data by relating said service data with said user identification data, and link management means for managing link data for linking a page of one user to a page of another user other than said page of said one user, said data processing method comprising the steps of:
executing an operation for moving service data of said one user to a page of another user linked by said link data, on said page of said one user, by a user terminal device connected via a network; and
clearing the relation between the user identification data of said one user and said service data to be moved and newly relating user identification data of said another user to whom said move is executed and said service data to be moved, by said data management means.

6. A data processing system comprising:
a user manager configured to manage user identification data for identifying a user and a page of said user by relating said user management data with said page;
a data manager configured to manage service data and said user identification data by relating said service data with said user identification data; and
a link manager configured to manage link data for linking a page of one user to a page of another user other than said page of said one user;
wherein, when an operation for moving service data of said one user to a page of another user linked by said link data is executed, on said page of said one user, by a user terminal device connected via a network, said data manager clears the relation between the user identification data of said one user and said service data to be moved and newly relates user identification data of said another user to whom said move is executed and said service data to be moved.
